(19) United States
(12) Patent Application Publication
(10) Pub. No.: US 2024/0135585 A1
(43) Pub. Date: Apr. 25, 2024

(54) CAMERA CALIBRATION PROCESS AND INTERFACE

(71) Applicant: Dexterity, Inc., Redwood City, CA (US)

(72) Inventors: Ayush Sharma, Belmont, CA (US); Joseph W. Weber, Kirkland, WA (US); Cyril Nader, Palo Alto, CA (US); Jonathan Anglingdarma, San Jose, CA (US); Vladimir Bulvakhter, San Francisco, CA (US)

(21) Appl. No.: 18/491,259

(22) Filed: Oct. 19, 2023

Related U.S. Application Data
(60) Provisional application No. 63/418,380, filed on Oct. 21, 2022.

(51) Int. Cl. G06T 7/80; B25J 9/16; H04N 17/00; H04N 23/66

(52) U.S. Cl. CPC G06T 7/80; B25J 9/1692; B25J 9/1697; H04N 17/002; H04N 23/66; G06T 2200/24; G06T 2207/30204

(57) ABSTRACT

Techniques are disclosed to calibrate a camera for use with one or more robots to perform a robotic application. In various embodiments, selection of a camera to be calibrated is received via a user interface. A region of interest associated with the camera and a robot with which the camera is associated is determined. A set of sample points within the region of interest is selected. The robot is moved through a set of trajectories to position the robot, successively with respect to each of at least a subset of the sample points, in a predetermined pose at a location associated with the sample point and, at each location cause the camera to generate a corresponding image that includes at least a fiducial marker located on the robot. The respective predetermined poses and corresponding images are used to perform a set of calibration computations with respect to the camera.

### CROSS REFERENCE TO OTHER APPLICATIONS

This application claims priority to U.S. Provisional Patent Application No. 63/418,380 entitled CAMERA CALIBRATION PROCESS AND INTERFACE filed Oct. 21, 2022, which is incorporated herein by reference for all purposes.

### BACKGROUND OF THE INVENTION

Cameras are heavily leveraged in robotic applications. Cameras allow robotics systems to locate objects of interest and provide the robot with accurate coordinates of the objects, identify good graspable points, provide an occupancy map of an area, etc.

Cameras can be mounted on a moving part of the robot or be external and stationary. Cameras may produce data from depth and RGB sensors, enabling a three-dimensional (3D) view of a workspace to be generated. Camera extrinsic calibration (or Calibration in the proceeding) is an important procedure to ensure that the relayed poses of 3D points are accurate. It is important not only for the transformation describing the pose of the camera with respect to the robot to be accurate, but also for the pose of 2 or more different camera sensors with respect to each other to be accurate.

Typically, calibration is a cumbersome process that requires fiducial markers to be installed on the robot and the robot to be moved by an operator to various poses within the camera field of view to capture pictures. The accuracy of the results is difficult to estimate and much uncertainty about the success of the process remains. Typically, technicians work with a set of fixed joint angles for the data collection step. This raises safety challenges where the robot being calibrated needs to have its ambient space clear of any obstacles. Furthermore, this process is not scalable for different product lines which have different end-effectors and work zones. The work zone variability can be a challenge as well since typically one would like to evaluate the accuracy of calibration within the specific workspace and region of interest that the robot will be working in, which may vary with the nature of the work the robot will be used to perform within the workspace.

### BRIEF DESCRIPTION OF THE DRAWINGS

Various embodiments of the invention are disclosed in the following detailed description and the accompanying drawings.

FIG. 1 is a diagram illustrating an example of multiple robotic system work zones served by a central camera calibration service in an embodiment of an automated camera calibration system as disclosed herein.

FIG. 2A is a diagram illustrating an example of a robotic shelf kitting system comprising a camera mounted in a fixed location in an embodiment of an automated camera calibration system as disclosed herein.

FIG. 2B is a diagram illustrating an example of a robotic shelf kitting system comprising a camera mounted on a pole on a mobile carriage on which a robot is mounted in an embodiment of an automated camera calibration system as disclosed herein.

FIG. 2C is a diagram illustrating an example of a robotic shelf kitting system comprising a camera mounted on a robotic arm in an embodiment of an automated camera calibration system as disclosed herein.

FIG. 3 is a block diagram illustrating an embodiment of an automated camera calibration system.

FIG. 4 is a flow diagram illustrating an embodiment of a process to perform and display results of a camera calibration process.

FIG. 5 is a flow diagram illustrating an embodiment of a camera calibration process.

FIG. 6A is a diagram illustrating an example of a set of AprilTag type fiducial markers used to perform camera calibration in various embodiments of a camera calibration system.

FIG. 6B is a diagram illustrating an example of robotic end effector on which a set of AprilTag type fiducial markers are mounted to facilitate performing camera calibration in various embodiments of a camera calibration system.

FIG. 7 is a diagram illustrating principles of a ray-based calibration process used in various embodiments of a camera calibration system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An automated camera calibration system is disclosed. In various embodiments, a “button click” camera calibration solution is provided that is applicable for a plurality of robotic applications and/or product lines, e.g., each of a plurality of different types of work a robotic system may be configured to perform, such as line kitting, palletization/depalletization, sortation, truck loading, etc. In various embodiments, the calibration process yields a report that studies the success of the calibration operation and that is displayed on a user interface, such as a computer or other display device.

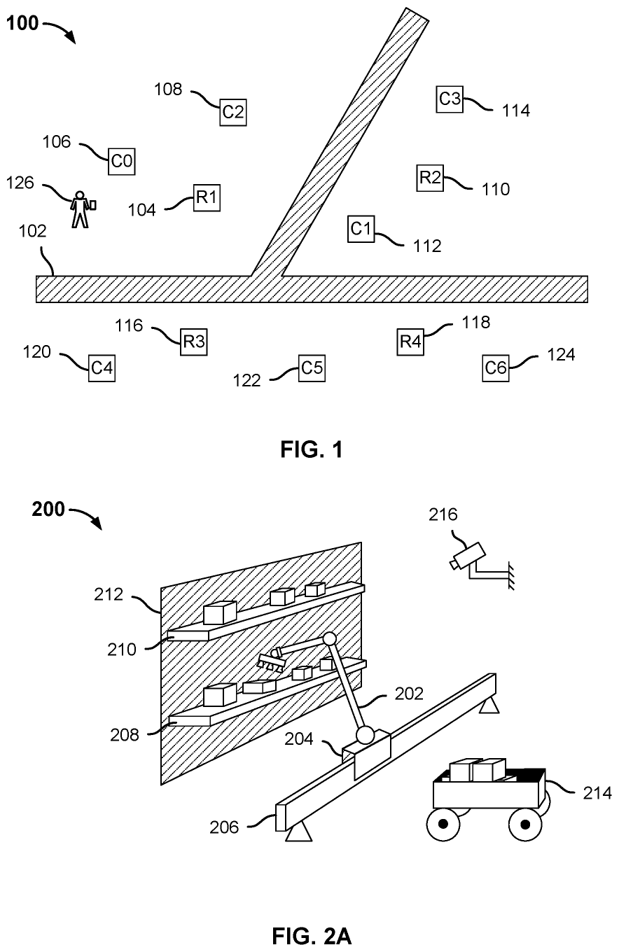

FIG. 1 is a diagram illustrating an example of multiple robotic system work zones served by a central camera calibration service in an embodiment of an automated camera calibration system as disclosed herein. In various embodiments, a calibration process as discussed herein may be performed at least in part by a remote service configured to perform calibration processing based on data obtained and/or received from one or more remote sites. In the example shown, system and environment 100 includes three distinct work areas defined by dividing wall 102, including a first work area comprising a robot 104 and cameras 106 and 108; a second work area comprising robot 110 and cameras 112 and 114; and a third work area comprising robots 116 and 118 and cameras 120, 122, and 124.

As shown in FIG. 1, a human operator or other user 126 may use a tablet computer or other user interface device, which may be wired or wireless, to initiate calibration of one or more cameras in a workspace, relative a specific robot or set of robots configured to perform a specified task or set of tasks (e.g., a specific robotic application, such as palletization/depalletization, line kitting, shelf kitting, etc. in the context of that workspace.

In various embodiments, the user 126 is presented with a graphical user interface that enables the user to select a robot, e.g., robot 104. In response, the user interface displays to the user 126 a variety of options to configure, administer, and/or control the robot 104, including an option to select a camera to be calibrated. Selection of the aforementioned option results in a list or buttons to select a camera that the administration application and/or platform with which the user interface is associated has been configured to associate with the robot selected by the user 126, i.e., cameras 106 and 108 associated with robot 104, in this example.

In various embodiments, selection of a camera to be calibrated results in a call being made to a remote camera calibration service that includes one or more of the following: an identification of the robot (e.g., robot 104, in the above example), identification of the camera selected by the user (e.g., camera 106, if selected); and data indicating the robotic application for which the robot (e.g., robot 104) is to be used (e.g., palletization/depalletization, etc.). In response, as described more fully below, the calibration service performs without further action or input from the user 126 a camera calibration process as a service, which is specific at least in part to the robotic application indicated in the call to the service and the attributes of the workspace in which the robot is located.

In various embodiments, other calls to the service, e.g., from other users with respect to other robots and/or cameras shown in FIG. 1 would be performed in a manner determined at least in part by the specific attributes of one or more of the robot, robotic application, and camera identified in such other calls and attributes of the workspace in which the robot and camera identified in the call are located.

In various embodiments, an automated camera calibration and/or process as disclosed herein may be used to calibrate one or more cameras used by a robotic system to perform a set of tasks associated with a robotic application, including without limitation cameras mounted in fixed locations in the workspace, cameras mounted on poles or other superstructure fixed to a same base or mobile chassis to which the robotic arm or other robot is mounted, and cameras mounted on a movable element of the robot itself, such as the end effector or arm segment.

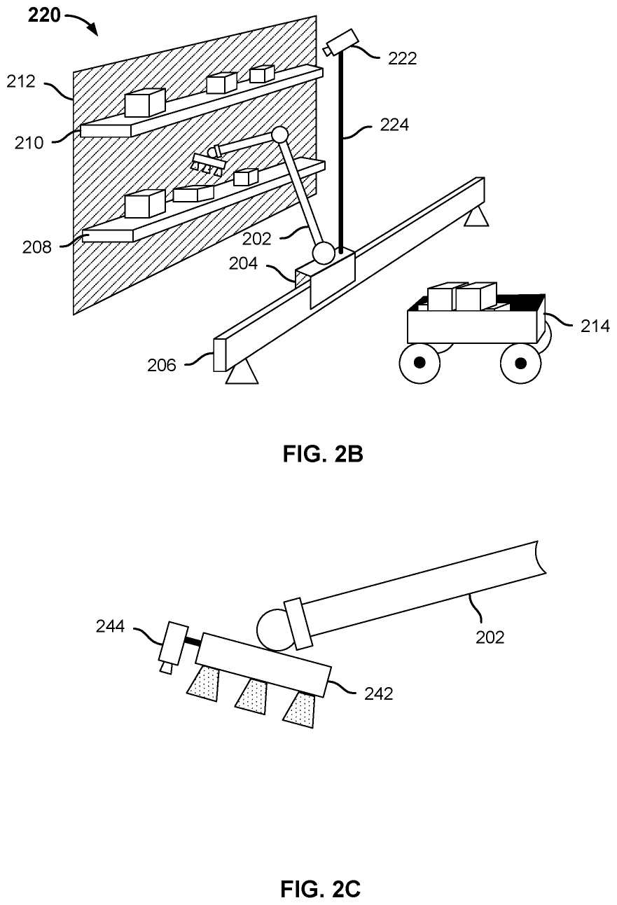

FIG. 2A is a diagram illustrating an example of a robotic shelf kitting system comprising a camera mounted in a fixed location in an embodiment of an automated camera calibration system as disclosed herein. In the example shown, robotic system and environment 200 includes a robotic arm 202 mounted on a chassis 204 configured to be moved along a rail 206. In this example, robotic arm 202 is configured to be used to pick items from shelves 208 and/or 210 mounted on wall 212 and place such items in a mobile cart 214, which may be a mobile robot. A camera 216, e.g., a 3D camera that provides both two-dimensional image (e.g., RGB) and depth information (e.g., point cloud), is mounted in a fixed position in the workspace, e.g., on a wall or other permanent/immobile structure.

FIG. 2B is a diagram illustrating an example of a robotic shelf kitting system comprising a camera mounted on a pole on a mobile carriage on which a robot is mounted in an embodiment of an automated camera calibration system as disclosed herein. In the example shown in FIG. 2B, the system and environment 220 includes robot 202 and other elements shown in FIG. 2A along with a camera 222 mounted on pole 224 affixed to chassis 204. As chassis 204 moves along rail 206 to reposition the robot 202, camera 222 mounted on pole 224 moves along with it, enabling a view to be obtained of the work area the robot 202 is near at any given time.

FIG. 2C is a diagram illustrating an example of a robotic shelf kitting system comprising a camera mounted on a robotic arm in an embodiment of an automated camera calibration system as disclosed herein. In the example shown, robotic arm 202 has a robotic end effector 242, in this example a suction-based gripper, mounted on the distal, free moving end of the robotic arm 202. Camera 244 is mounted in a fixed position on the end effector 242, as shown, enable images (including depth information) to be generated of the area near the end effector 242. The robotic arm 202 and/or end effector 242 may be operated, under robotic control, to position the camera 244 in a location and orientation to capture images of an area of interest, e.g., close-up images of a specific item or items to be grasped.

In various embodiments, techniques disclosed herein may be used to calibrate cameras for use in robotic systems and applications, whether the cameras are mounted in a fixed location in the workspace, a fixed location relative to the robot or a structure on which the robot is mounted, or on the robot itself, as in the examples illustrated by FIGS. 2A-2C.

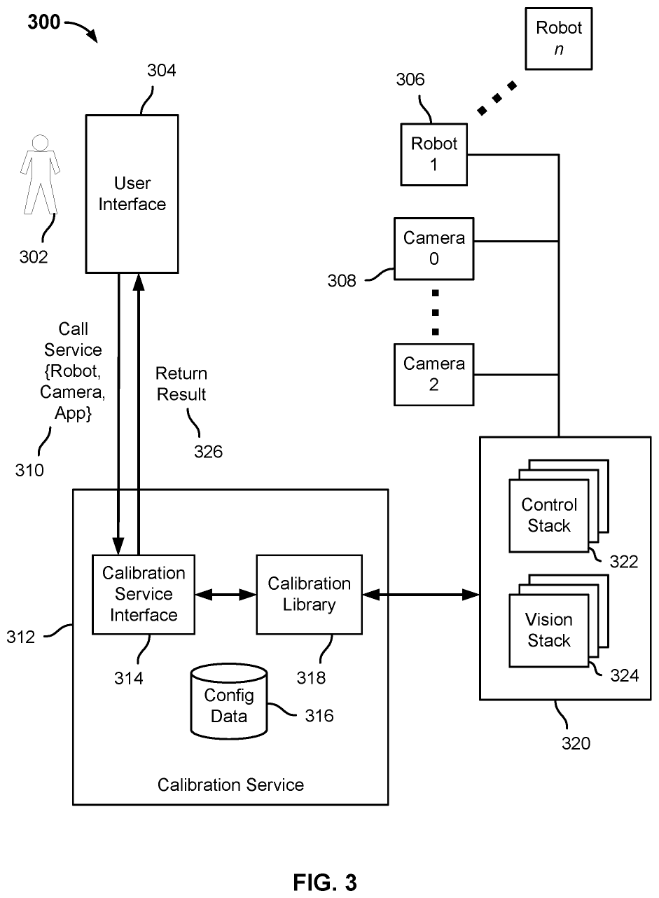

FIG. 3 is a block diagram illustrating an embodiment of an automated camera calibration system. In various embodiments, the system/process 300 illustrated in FIG. 3 may be used to calibrate a camera or cameras configured to provide images to facilitate operation to one or more robots to perform a specific robotic application, as in the examples shown in FIGS. 1, 2A, 2B, and 2C.

In the example shown, the calibration process is invoked by user 302 accessing a diagnostic tool in the system user interface (UI) 304. The user clicks on the robot they wish to calibrate, e.g., robot 306, and selects a camera to calibrate, e.g., camera 308. A request is sent from the UI 304 to the robot application, which kicks off a series of steps to set the robot up for calibration and provide the calibration library with the appropriate parameters. In various embodiments, as in the example shown in FIG. 3, a service call 310 is made to a calibration service 312. The service call 310 includes information such as the robot and camera selected by the user 302 and the robotic application the robot is configured to perform. The service call 310 is received at calibration service interface 314.

In various embodiments, the architecture of the backend implementation leverages two components: (1) an application specific component comprising a control computer, described below, configured to control the robot indicated in the service call to perform a specific robotic application (line kitting, palletization/depalletization, sortation, truck loading/unloading, etc.) the robotic system will perform, and (2) a calibration library 318 that is generalized across robotic applications. In various embodiments the UI component 304 of the robotic system implements the diagnostic API which interacts with the calibration service 312.

Calibration service 312 uses the identity of the robot, as included in service call 310, to configuration data associated with the robot, enabling the calibration library 318 to determine relevant attributes of and/or context information for the robot. The calibration library 318 uses the information to connect with and interact with a control computer 320 configured to control the selected robot, i.e., robot 306 in the example shown. Control computer 320 includes a control stack 322, which includes a robotic application layer specific to the robotic application the robot 306 is to be used to perform, a motion planner component, and other layer used to control the robot 306 to perform the robotic application. The control computer further includes a vision stack 324 configured to interact with and control the cameras, e.g., camera 308, to be calibrated.

In various embodiments, the calibration service 312 interacts with the control computer 320 to retrieve the internal state of the system and, using a region of interest (ROI) provided by the user (e.g., via a CAD file or other configuration file), causes the robot to be moved to a safe zone. The calibration service 312 interacts with one or both of the control stack 322 and the vision stack 324 to prunes the ROI and determine a set of sample points and poses to position and orient the fiducial marker(s) to be used for calibration within the field of view of the camera, i.e., camera 308 in this example. Subsequently, a motion module comprising the control stack 322 samples points in the pruned ROI and computes trajectories. In some embodiments, this step uses forward simulation—a tool for studying desired motions in simulation and heuristically planning trajectories, checking for possible collisions (with robot itself, ambient objects) and further prunes the number of points (e.g., to ensure collisions are avoided). For each of the points in the sample set, the system (e.g., one or both of calibration service 312 and control computer 320) moves the robot to the point, captures the image from the camera, and records the corresponding robot pose. After this process, the calibration library 318 is called with the set of data (points, robot poses and image) as input.

In various embodiments, the calibration library 318 performs computations based on the received input data (i.e., points, robot poses and image) and computes one or more transformation matrices to be used to transform image/depth data generated by the camera, in a camera from or reference, to a frame of reference used by the robotic system to control the robot to perform the specified robotic application in the associated workspace. The calibration service 312 returns a calibration result 326 to the user interface 304. In addition, in various embodiments, the calibration service 312 generates and returns to the user interface 304 one or more visualizations reflecting the results of the calibration process. For example, the user interface 304 may display the overall success or failure of the calibration process, and a provide a visual representation of the errors that remain after error minimization that was performed as part of the calibration process.

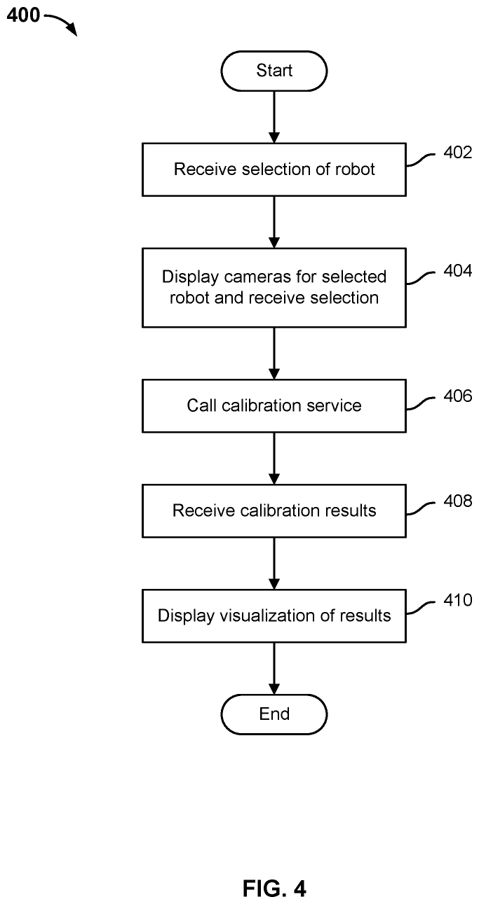

FIG. 4 is a flow diagram illustrating an embodiment of a process to perform and display results of a camera calibration process. In various embodiments, the process 400 of FIG. 4 may be performed by a user interface and/or associated device, e.g., user interface 304 of FIG. 3, and/or a robotic application. In the example shown, a selection of a robot is received at 402. At 404, one or more cameras associated with the selected robot are displayed, via a user interface, and an input selecting a camera for calibration is received. At 406, a calibration service is called, e.g., call 310 of FIG. 3. At 408, calibration results are received from the calibration service. At 410, a visualization of the results of the calibration is displayed, e.g., via the user interface.

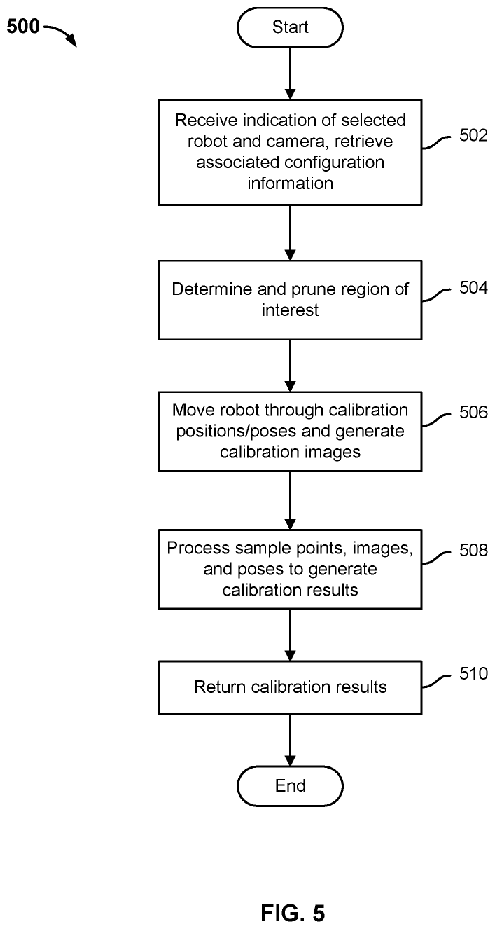

FIG. 5 is a flow diagram illustrating an embodiment of a camera calibration process. In various embodiments, the process 500 of FIG. 5 may be performed by a calibration service, such as calibration service 312 of FIG. 3. In the example shown, at 502 an indication, e.g., an API or other service call, is received that includes identification of a selected robot and camera and associated configuration information is retrieved. For example, a CAD file or other configuration information may be retrieved that identifies and/or includes information about a workspace in which the selected robot and/or camera are located. At 504, a region of interest (ROI) is determined, e.g., based on the information retrieved at 502, the specific robotic application the robot is configured to perform, etc., and, in this example, the ROI is pruned, e.g., to exclude areas the robot will not operate in given the robotic application and/or to avoid collisions with structures comprising and/or objects present in the workspace.

At 506, the robot is moved or caused to be moved through a sequence of calibration positions/poses and at each position/pose one or more images to be used to perform calibration computations are generated. (In some embodiments, step 506 may be performed by a robotic application, e.g., based on position, pose, and/or trajectory information provided by the calibration service.) At 508, the sampled points (positions), poses, and corresponding images are processed to generate calibration results. In some embodiments, a ray-tracing techniques is used to perform the calibration. At 510, calibration results are returned.

In various embodiments, the calibration process produces as output a 4×4 or other transformation matrix to be applied to image/depth data from the camera to produce calibration-adjusted values to be used by the robotic system to control the robot to perform assigned tasks.

In various embodiments, a validation process may be performed to validate the calibration results. The validation process may follow the same steps as in the process of FIG. 5 to collect data and evaluate the given transforms for “robot2camera” and/or fiducial “marker2robot”. In some embodiments, a cost function is used to perform validation.

In various embodiments, a set of AprilTags or other optical fiducial markers are used to perform calibration as disclosed herein. The fiducial markers may be mounted on the robot, e.g., on the robotic end effector and/or in the workspace.

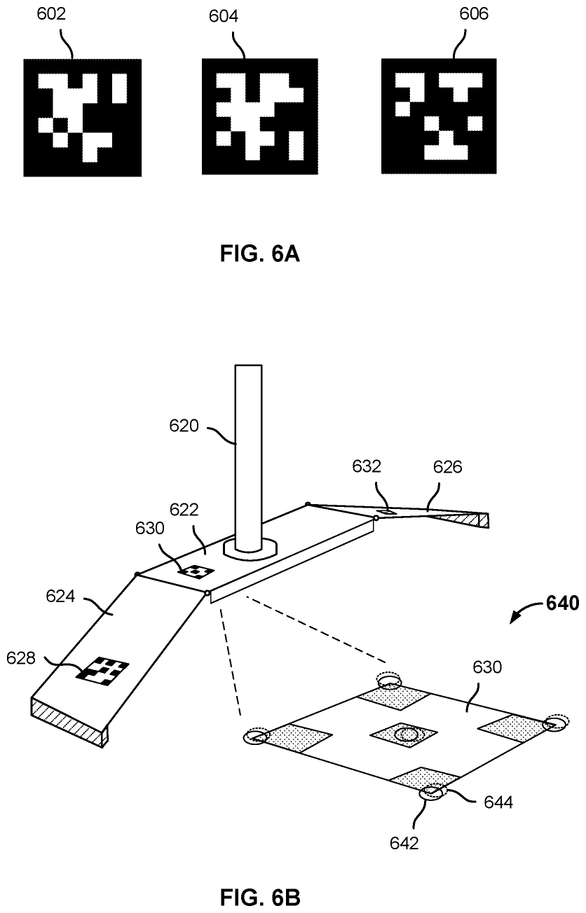

FIG. 6A is a diagram illustrating an example of a set of AprilTag type fiducial markers used to perform camera calibration in various embodiments of a camera calibration system. In various embodiments, a calibration process as disclosed herein uses AprilTags, such as AprilTags 602, 604, and 606 of FIG. 6A, as fiducial markers to estimate the true distance of points from the camera center with high accuracy, thus giving accurate position of points (x, y, z) in camera frame. Each AprilTag provides the positions for 5 points (1 center+4 corners). Using this information, the homography transform is computed for the points in the tag with respect to the camera center. To reduce error, in some embodiments, multiple AprilTags are used, which are mounted on the gripper (end-effector) of the robot.

In some embodiments, to achieve a successful calibration, point correspondences are established between the points detected by the April Tag library and using forward kinematics of the robot. The latter can be obtained by finding the position of points in the robot frame using the “marker2robot” transform which comes from the recorded robot poses. The calibration process uses the seed values for “marker2robot” and “robot2camera” from the CAD drawings or other configuration information. These values are jointly optimized as part of the process using applicable cost functions.

FIG. 6B is a diagram illustrating an example of robotic end effector on which a set of AprilTag type fiducial markers are mounted to facilitate performing camera calibration in various embodiments of a camera calibration system. In the example shown, robotic arm 620 has an end effector comprising a lateral member 622 and gripper elements 624 and 626, which are configured to be opened or closed, under robotic control, e.g., to grasp a tray or other container and/or a large item. The end effector has fiducial markers (e.g., AprilTags) 628, 630, and 632 mounted fixedly on to surfaces of gripper element 624, lateral member 622, and gripper element 626, respectively.

In various embodiments, a robot and/or end effector having fiducial markers mounted thereon, as in the example shown in FIG. 6B, may be moved through a sequence of positions/poses, as in step 506 of FIG. 5, to generate at each position/pose one or more images to be used to performed calibration computations, e.g., to produce a “camera2robot” transformation matrix that transforms locations as perceived based on the camera's images to the robot frame of reference with minimal error.

In various embodiments, the end effector shown in FIG. 6B may be moved via computed trajectories to each of a plurality of locations in the region of interest. At each location, the end effector may be placed in a predetermined pose, e.g., the orientation of the end effector in three dimensional space and/or the degree of openness or closedness of the gripper elements 624, 626 may be varied, such as to expose the fiducial markers 628, 630, 632 to the field of view of the camera at desired locations, angles, etc.

In various embodiments, a calibration process as disclosed herein may include data usable to present a visual representation of the error (difference) between the position of a location on a fiducial marker as perceived by the camera and the position of the corresponding point on the marker based on the robot's position and pose and the associated “marker2robot” transform, e.g., from stored configuration data. An example 640 of such a visualization is shown in FIG. 6B, in the bottom right. In the example shown, the actual position of the lower corner of marker 630 is indicated by circle 642, having an associated color or other line style attribute, while the perceived location as seen by the camera is indicated by circle 644, shown in another line color and/or style. At a glance, an operator viewing visualization 640 would be able to see that a camera calibration that minimizes the error between the actual and perceived locations of points on the marker 630 has been achieved.

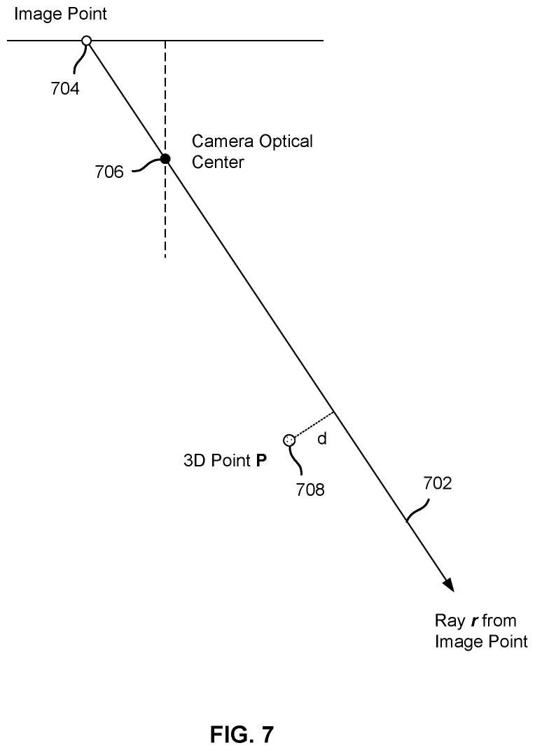

FIG. 7 is a diagram illustrating principles of a ray-based calibration process used in various embodiments of a camera calibration system. In some embodiments, an automated calibration process as disclosed herein uses a ray-based calibration method, e.g., as shown in FIG. 7.

In a ray-based approach, after establishing point correspondences as described above, an error term which minimizes the distance “d” between the ray 702 (emanating from the image plane 704 and optical center 706 of the camera) and the point 708 in the world frame represented in camera is used. An advantage of expressing the error term as distance between points in the camera frame is that the distance is measured in millimeters instead of pixels. This error term is invariant with respect to the distance from the camera, in various embodiments.

In some embodiments, the validation process is performed to validate camera calibration results. The validation process provides the following artifacts in a detailed report:
1. Summary report (e.g., identifying the robot, the camera, calibration success/failure, etc.)
2. Location of points sampled in camera frame with color schema for errors.
3. Location of points sampled in base frame with color schema for errors.
4. Distance from camera center vs error for each fiducial marker.
5. Distance from robot base vs error.
6. Projection of points alongside points detected on fiducial marker (e.g., by AprilTag library).

In some embodiments, techniques disclosed herein are applied to calibrate a camera that is mounted on the robot, such as at or near the robot “hand” or other end effector. In various embodiments, calibration of a camera mounted on the robot may include one or more of the following:
In the previous sections, the calibration and validation for static cameras mounted on a pole, have been described. For a robot-mounted camera, the camera may be mounted on the robot wrist/end-effector and the calibration system and/or process is used to find the transformation between the camera and robot wrist/end-effector.

In some embodiments, techniques disclosed herein enable camera calibration to be performed automatically, e.g., by an operator selecting the robot and camera and then pushing a single button to calibrate. Automatic pruning of the ROI, sampling of points, and further pruning of the sample set, as disclosed herein, enables calibration to be performed without skilled technicians being required to select the sample points, move the robot to the respective points, etc.

In various embodiments, techniques disclosed herein enable an operator who may not be an expert in robotic system configuration and/or camera calibration to easily calibrate (or recalibrate) a camera to be used to enable a given robot or set of robots to perform tasks associated with a robotic application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a user interface configured to receive a selection of a camera to be calibrated; and
a processor coupled to the user interface and configured to:
determine a region of interest associated with the camera and a robot with which the camera is associated;
select a set of sample points within the region of interest;
cause the robot to move through a set of trajectories to position the robot, successively with respect to each of at least a subset of the sample points, in a predetermined pose at a location associated with the sample point and, at each location cause the camera to generate a corresponding image that includes at least a fiducial marker located on the robot; and
use the respective predetermined poses and corresponding images to perform a set of calibration computations with respect to the camera.

2. The system of claim 1, wherein the region of interest is determined at least in part by retrieving and reading data from a configuration file.

3. The system of claim 2, wherein the configuration file includes a CAD file that represents a workspace in which the robot is located.

4. The system of claim 1, wherein the region of interest is determined based at least in part on a robotic application associated with the robot.

5. The system of claim 1, wherein determining the region of interest includes determining an initial region of interest and pruning the initial region of interest.

6. The system of claim 4, wherein the pruning is performed at least in part to avoid a collision.

7. The system of claim 1, wherein the processor is further configured to compute the set of trajectories.

8. The system of claim 1, wherein the user interface is configured to send to the processor one or more of an identification of the selected camera, an identification of the robot, and an indication of the robotic application the robot is configured to perform.

9. The system of claim 1, wherein the processor comprises a calibration service running at a node that is remote from the user interface.

10. The system of claim 1, wherein the processor is further configured to generate a calibration result based at least in part on the calibration computations.

11. The system of claim 10, wherein the calibration result includes one or more transformation matrixes to transform locations determined based on image data from the camera from a frame of reference associated with the camera to a frame of reference associated with control of the robot.

12. The system of claim 1, wherein the processor is further configured to generate based at least in part on the calibration computations and return to the user interface data usable to display at the user interface a visualization of a calibration result based on the calibration computations.

13. The system of claim 1, wherein the visualization includes a visual representation of a fiducial marker and a visual representation of the difference between an actual location of a feature of the fiducial marker and a perceived location of the feature as perceived by the camera.

14. The system of claim 1, wherein the calibration computations include performing ray-based calibration based on the predetermined poses and corresponding images.

15. The system of claim 1, wherein the processor is configured to use a robotic application specific component to do one or more of determine the region of interest, select the set of sample points, and cause the robot to move through the set of trajectories, and to use a general component not specific to the robot application to perform the set of calibration computations.

16. A method, comprising:
receiving, via a user interface, a selection of a camera to be calibrated;
determining a region of interest associated with the camera and a robot with which the camera is associated;
selecting a set of sample points within the region of interest;
causing the robot to move through a set of trajectories to position the robot, successively with respect to each of at least a subset of the sample points, in a predetermined pose at a location associated with the sample point and, at each location cause the camera to generate a corresponding image that includes at least a fiducial marker located on the robot; and
using the respective predetermined poses and corresponding images to perform a set of calibration computations with respect to the camera.

17. The method of claim 16, wherein the region of interest is determined based at least in part on a robotic application associated with the robot.

18. The method of claim 16, further comprising generating a calibration result based at least in part on the calibration computations.

19. The method of claim 16, wherein the calibration computations comprise ray-based calibration computations.

20. A computer program product embodied in a non-transitory computer readable medium and comprising computer instructions for:
receiving, via a user interface, a selection of a camera to be calibrated;
determining a region of interest associated with the camera and a robot with which the camera is associated;
selecting a set of sample points within the region of interest;
causing the robot to move through a set of trajectories to position the robot, successively with respect to each of at least a subset of the sample points, in a predetermined pose at a location associated with the sample point and, at each location cause the camera to generate a corresponding image that includes at least a fiducial marker located on the robot; and
using the respective predetermined poses and corresponding images to perform a set of calibration computations with respect to the camera.
